(19) United States
(12) Patent Application Publication
(10) Pub. No.: US 2003/0156619 A1
(43) Pub. Date: Aug. 21, 2003

(54) Method to determine a material having characteristics of heat regulation and material obtained with said method

(76) Inventors: Stefano De Monte, Colugna (IT); Alessandro Moro, Di Pianiga (IT); Marco Scapin, Dolo (IT)

Correspondence Address: STEVENS DAVIS MILLER & MOSHER, LLP, 1615 L STREET, NW, SUITE 850, WASHINGTON, DC, 20036, US

(21) Appl. No.: 10/297,199

(22) PCT Filed: Jun. 6, 2001
(86) PCT No.: PCT/IB01/00985

(30) Foreign Application Priority Data
Jun. 7, 2000 (IT) UD2000A000119

(51) Int. Cl. G01N 25/02

(52) U.S. Cl. 374/44; 374/16

(57) ABSTRACT

Method to determine a material having characteristics of heat regulation, said material being able to be used in the design of footwear, body suits, head-covers, padding, gloves or other garments which can be associated with parts of the human body. Said method provides to calculate at least the value of heat conductivity (α) of said material able to provide desired conditions of thermophysiological comfort, starting from contour conditions and from at least a value of heat conductivity assumed as initial value, the method providing to use said initial value of conductivity (α₀) to calculate the microclimatic conditions to which the part of the body concerned is subject, and to modify with an iterative process said initial value of conductivity (α₀) until said microclimatic conditions converge towards a pre-defined condition of thermophysiological comfort.

### FIELD OF THE INVENTION

The invention concerns a method to determine a material having desired characteristics of heat regulation, to be used in association with parts of the human body to ensure conditions of heat compatibility for the user in every environmental condition.

The invention also concerns the material obtained with the method.

To be more exact, the invention concerns a technique to determine and characterize a material of which at least the parameters of heat conductivity are obtained analytically, so as to ensure maximum proximity to a condition of thermophysiological comfort in relation to the environmental conditions in which the user finds himself.

The invention is applicable substantially in the design of every type of article of clothing, but is preferentially applied in making footwear, body suits, head-covers, padding, gloves or similar.

### BACKGROUND OF THE INVENTION

It is well-known that in the design of articles of clothing thermophysiological comfort is a fundamental objective, in order to satisfy the constantly increasing requirements of consumers.

In this context, studies have been carried out to design materials able to simultaneously guarantee, for example, conditions wherein heat is retained and conditions wherein the material can breathe, so that a degree of comfort can be approached even in difficult environmental conditions. However, present techniques of designing materials do not provide methods suitable to analytically determine the physical parameters of a material (mainly heat conductivity and thickness) in order to obtain technological characteristics of heat insulation which can at least approach subjective conditions, of thermophysiological comfort.

Therefore, material currently proposed only partly achieve their purpose, and only in certain environmental conditions, so they do not offer a versatile and efficacious solution.

U.S. Pat. No. 4,055,669 disclose a multi-layer insole comprising a plurality of layer, four in the case, each able to perform a specific function in the material and each able to perform a specific function in the use of a relative footwear. This document does not teach how to find one material having required feature of heat conductivity to be used in the design of a footwear.

The present Applicant has devised and developed this invention to overcome these shortcoming with an innovative solution suitable to overcome the limits of the state of the art and to obtain further advantages.

### SUMMARY OF THE INVENTION

The invention is set forth and characterized in the respective main claims, while the dependent claims describe other characteristics of the main embodiment.

The purpose of the invention is to obtain a method for the analytical characterization and design of a heat insulating material to be associated with a part of the human body and having heat-regulating characteristics such as to ensure conditions of thermophysiological comfort on a vast range of users and in environmental condition which may even be very variable.

The invention is applied in applied in designing materials to be used in the field of footwear, clothing, accessories and other objects which can be associated with the human body.

The invention allows to obtain a quantitative indication of the physical characteristics and the parameters of heat insulation, at least in terms of resistivity or heat conductivity, which a material must possess in order to guarantee the user a condition as near as possible to a statistical condition of thermophysiological comfort.

The method according to the invention provides a preliminary step wherein the subjective conditions of thermophysiological comfort are statistically identified.

To be more exact, on a significant sample of subjects identified as intended for the application, identified and selected for a specific target for which the garment to be designed is directed, a plurality of tests and measurements of a biomedical type is carried out.

By specific target we mean a particular and selected typology of persons grouped together by sex, age, build or otherwise.

During this statistical identification, according to a variant, the method provides to take into consideration the possible presence of malformations, anomalous behavior (for example above or below average perspiration), eating habits, pathologies or otherwise.

The tests and measurements serve to define the conditions of surface temperature and/or surface humidity of the part of the body concerned, and the relative heat exchange with the environment, which statistically characterize, on said selected sample, a subjective condition of thermophysiological comfort.

To be more exact, these tests and measurements serve to identify the microclimatic parameters, for example temperature and humidity, of an environment wherein the part of the body is to be found, for example inside a shoe; according to said parameters, a substantial constancy is achieved of the thermal power exchanged between part of the body and outside environment through an insulating layer, and a minimum value of perspiration is obtained.

Then, in a preferential embodiment, some limiting physical characteristics of the material are defined, such as the size, the thickness and the general thermal properties, which are used as contour conditions, or external constraints, for the design of the material itself.

According to a variant, typical parameterized environmental conditions are added as other contour conditions, characteristic of the probable context of use, corresponding, for example, to the most probable situations in which the garments to be designed will be used. For example, according to a first embodiment, a specific geographical area where it will probably be used may be identified, together with a typical period of time, for example a season.

According to a variant, a typical environment of use may be identified, for example an internal, home environment, or a work environment, or on outside environment of probable use.

With this identification, parameters can be defined relative to the thermal aspects which most characterize the use of the article of clothing which contribute, for example in the case of footwear, to forming the microclimate inside the shoe itself according to which conditions of comfort are obtained or not.

Finally, a simulation model is identified suitable to analytically describe the development of the heat propagation, and/or the heat exchange in terms of power dispersed, between part of the body and outside environment through the layer of heat insulating material which has to be determined.

By using this simulation model, and by means of an iterative process, the physical parameters of the material to be determined, in particular its heat conductivity or resistivity, and hence the insulation characteristics, are progressively modified starting from a value assumed as an initial value.

This progressive modification continues until the simulation model converges towards those conditions of heat exchange and temperature distribution which have been identified by the subjective statistical identification as corresponding to situations of minimum perspiration and substantial constancy of power dispersed.

The result of this iteration, with an inverse and progressive process of approaching the ideal condition, leads to obtaining the physical and quantitative parameters of the material to be looked for; these parameters are used in the design and in the construction of the article of clothing to obtain desired conditions of thermophysiological comfort.

In a preferential embodiment of the invention, the material used for the heat regulation consists of at least a sheet made of polymeric material of a desired thickness, wherein at least a metallic substance has been incorporated, of a quantity such as to take the heat conductivity of the compound material thus obtained to the value determined by the iterative calculation described above.

In other words, after having determined the value of heat conductivity to be obtained in order to achieve the condition of thermophysiological comfort, in the mixture of polymeric material a set quantity of suitably chosen metallic substances is progressively added and mixed, in order to modify the heat conductivity of the compound and take it to the desired value.

To develop the method of calculation, the initial value of heat conductivity can be the one corresponding to the sheet of polymeric material alone, which is then progressively modified with progressive additions of one or more metallic substances until the condition of thermophysiological comfort desired is reached.

In a preferential embodiment, the metallic substance consists of aluminium.

An addition of aluminium in a quantity in the range of 10% in weight, with respect to the overall weight of the material thus obtained, allows to increase the specific heat conductivity of the compound material by a value comprised between 10 and 18%; an addition of said substance in a quantity in the range of 40% in weight allows to increase the specific heat conductivity of the compound material as much as 250÷300% with respect to the value of the basic polymeric material.

According to a variant, said metallic substance consists of copper, nickel, noble metals or other metals having similar characteristics, or mixtures thereof.

### BRIEF DESCRIPTION OF THE DRAWINGS

These and other characteristics of the invention will be clear from the following description of a preferential embodiment, given with reference to the attached drawings wherein:

FIG. 1 shows a block diagram exemplifying the method according to the invention;

FIG. 2 is a schematic illustration of a model of a foot associated with a shoe to which the method according to the invention is applied;

FIG. 3 shows a graph representing the power dispersed by the foot as the environmental temperature varies;

FIG. 4 shows a graph representing the evaporational behavior of the foot as the environmental temperature varies;

FIG. 5 is a block diagram of the procedure of iterative calculation to obtain the values of conductivity and thickness of the material which determine the thermal equilibrium of comfort, hereafter defined as heat regulating.

### DETAILED DESCRIPTION OF PREFERENTIAL EMBODIMENT

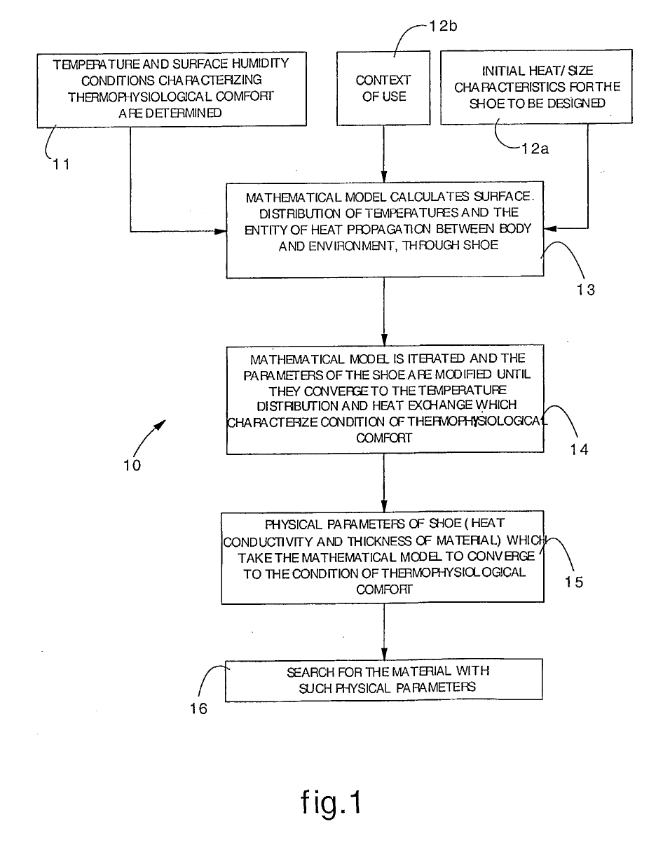

With reference to FIG. 1, it is shown a block diagram exemplifying the method according to the invention, in this case applied to the design of a material for a shoe.

The shoe is designed by determining the interface behavior of the foot with the environment, which allows to characterize the geometry and the heat parameters of the materials to be used to achieve a condition of thermophysiological comfort.

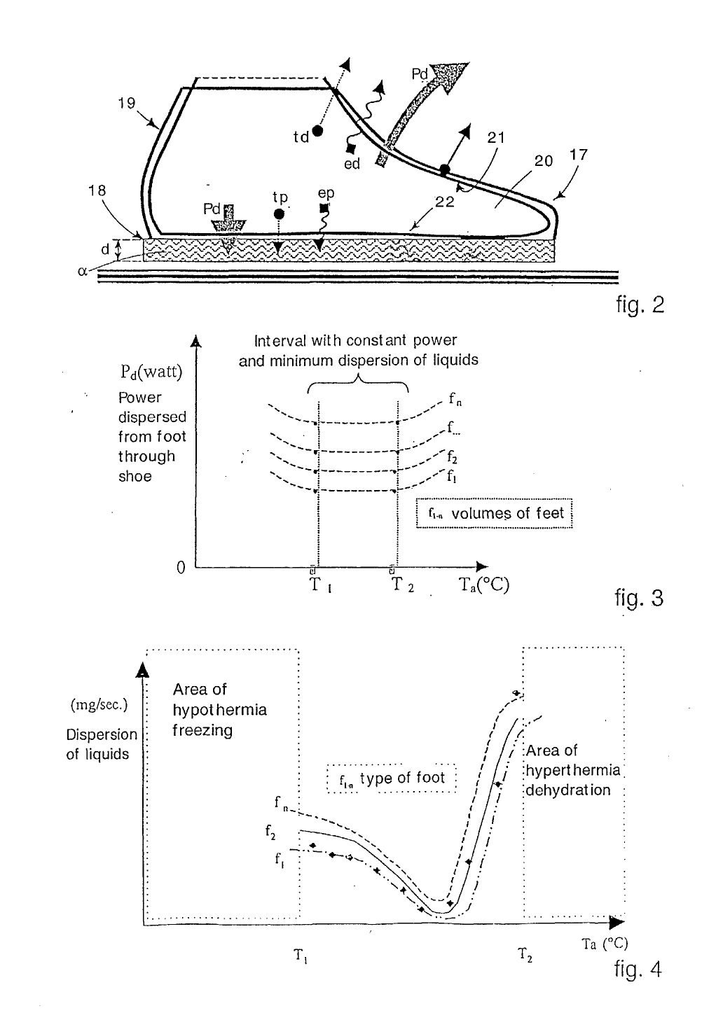

The shoe is indicated in FIG. 2 by the reference number 17, and consists of a sole 18 and an upper 19. Sole 18 and upper 19 have characteristics of heat insulation which can be identified by the relative parameters of heat conductivity “α” and thickness (indicated by d in the case of the sole 18).

The aim of the invention is to search for such parameters “α” and d thanks to which the condition of thermophysiological comfort is achieved; once these specific parameters have been obtained, it is possible to look for and design the suitable material in order to guarantee that such conditions of comfort are obtained.

Even if the example reported hereafter refers to a shoe 17 associated with a foot 20, the teaching of the invention can be applied substantially to every article of clothing which can be associated to a part of the body, whether it be an anatomical overall, a head-cover, a pair of gloves, padding or similar.

In the first step of the method, indicated generally with the reference number 10, a procedure 11 is performed to determine the microclimatic conditions of the foot 20, which characterize the subjective condition of thermophysiological comfort.

This is achieved by means of a statistical quantitative characterization of the heat exchange, in terms of power dispersed Pd between foot 20, possibly distinguishing between top 21 and bottom 22 thereof, and the environment in various environmental conditions. This statistical characterization is obtained by performing sequences of biomedical tests and measurements on a significant sample of subjects grouped together according to a specific target, previously identified, of people for whom the application is intended.

By means of such tests and measurements, which are based mainly on the detection of the power dispersed by the foot 20 and on the quantity of liquids produced due to evaporation as the environmental temperature varies, we obtain values of temperature and surface skin humidity which define the parameters corresponding to a condition of thermophysiological comfort.

Two examples of the results of such tests are shown in the graphs in FIGS. 3 and 4.

The graph in FIG. 3 shows the development of the power dispersed, in watts, by a foot 20 as the environmental temperature Tₐ varies for a plurality of different feet, indicated by f₁-fₙ.

From this graph we see how for temperatures comprised between T₁ and T₂ we obtain an interval with a substantially constant power, wherein there are no significant variations in the surface temperature of the foot 20 although there is a variable environmental temperature Tₐ.

The graph in FIG. 4 shows the development of the dispersion of liquids (perspiration) through the foot 20 in conditions of variable environmental temperature, here too for a plurality of different types of foot f₁-fₙ.

The graph shows a minimum value which defines a reduced interval of environmental temperature wherein there is a minimum dispersion of liquids. Values much above and much below this temperature corresponding to the minimum perspiration identify, respectively, areas of hyperthermia and dehydration, for temperatures of more than T₂, and areas of hypothermia and freezing, for temperatures of less than T₁.

In this way we obtain a parameterization of the environmental conditions, in terms of temperature and humidity, which have to be reached in order to obtain desired conditions of thermophysiological comfort for the user of the shoe.

In parallel fashion, through two steps indicated by 12a and 12b, contour conditions or external constraints are defined, connected to the design of the shoe 17: on the one hand (12a) the physical characteristics of the shoe (length, width, thickness and thermal properties used as starting values, both for the sole 18 and for the upper 19) and on the other hand the context of use (12b) with the parameters relative to the environmental conditions in which the user is most likely to wear the shoe 17 to be designed.

The parameters relative to the environmental conditions are identified according to the geographical areas of most probable use, working or domestic habits, the types of residential buildings, the means of transport used, and hence to the relative covering surfaces, and others.

After they have been subjected to statistic parameterization, the parameters relative both to the condition of thermophysiological comfort and also the contour conditions cited above are provided as input data to a mathematical model, indicated 13, able to simulate the behavior of a foot 20 in terms of heat propagation from the foot 20 towards the outside environment through said insulating layers consisting of sole 18 and upper 19.

According to the environmental conditions and the parameters of the insulation material set as starting data, said mathematical model supplies as output data the thermal map on the surface of the foot 20 and the thermal power dissipated towards the outside environment through the layers of insulation 18 and 19.

To be more exact, by means of said mathematical model it is possible to calculate the skin temperature tp, the quantity of evaporation ep and the power dispersed Pd relative to the bottom 22 of the foot 20, and also the corresponding values td, ed and Pd relative to the top 21 of the foot 20, as the environmental temperature varies.

The insulation characteristics of the material are initially defined according to a value assumed, hypothetically, as a random parameter.

In general, these insulation characteristics can be expressed as a product between the thickness of the material, which can be set as a contour condition and in any case can be modified when the product is optimized, and heat resistivity or conductivity of the material, which is substantially the parameter to be found.

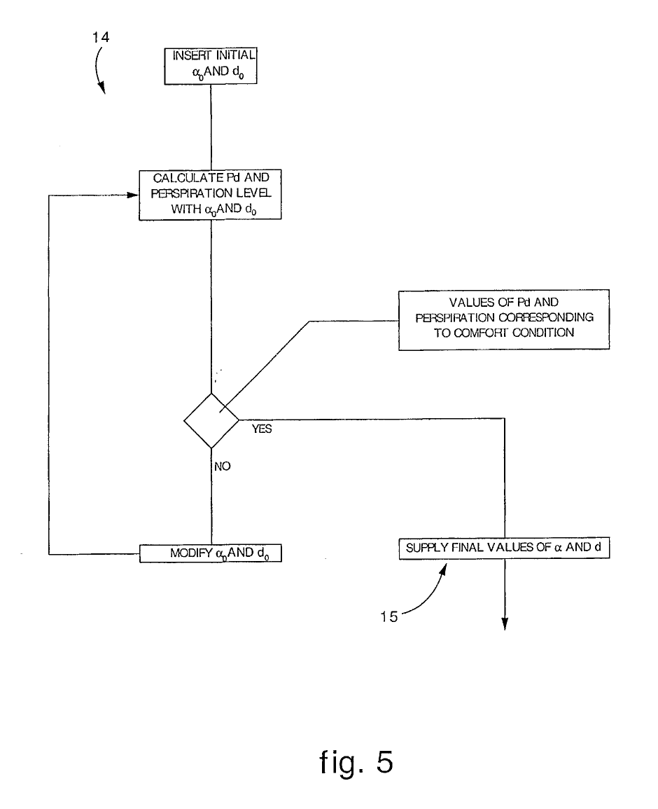

Based on the initial values of conductivity α₀, and thickness d₀ assumed as starting hypotheses, according to the iterative procedure shown diagrammatically in FIG. 5, the mathematical model performs the calculations to define the distribution of temperature over the surface of the foot 20, taking into account the pre-set contour conditions, and in particular it calculates the power dispersed Pd and the level of perspiration reached. These calculated values are compared with the values relative to the conditions corresponding to the thermophysiological comfort supplied as a basic datum by the above mentioned biomedical tests and measurements.

In practice, the mathematical model simulates the conditions of transmission of heat through the layers of insulation, consisting of the sole 18 and the upper 19, between foot 20 and outside air.

Based on this comparison, and according to an iterative method identified by step 14, detailed in FIG. 5, the parameters relative to at least the heat conductivity, and possibly to the thickness, of the material are gradually modified, according to a method of inverse calculation, by a quantity proportional to the difference between the values of power and perspiration determined by the calculation and those ideal values set as an objective.

The calculation is repeated with an iterative process until this difference comes within a field judged to be acceptable, for example with a tolerance equal to ±1° C. The termination of the iterative calculation with temperatures converging towards the ideal temperature supplies as a parameter, in the step indicated by 15, the values of heat conductivity “α” and of thickness d of the material which, starting, from the contour conditions, supply the heat insulation required to reach thermophysiological conditions near to those of comfort. These final values are used during the step of making the shoe 17 to search for the material or materials, indicated by 16, which meet these conditions.

In a preferential embodiment, as heat regulating material a compound material is used consisting of at least a basic layer consisting of polymeric material, mixed with at least a metallic substance added in a controlled quantity such as to modify the heat conductivity characteristics of the base material.

By suitably regulating, and possibly through subsequent approximations, the quantity of metallic substance added to the initial polymeric material, it is possible to progressively modify the value of heat conductivity of the compound material until the value determined by the calculation method is obtained.

According to a preferential embodiment of the invention, the metallic substance consists of aluminium, which has the capacity of determining considerable increases in the heat conductivity with relatively low quantity additions.

Experimental results have shown that, in the case of a sheet of polymeric material having a heat conductivity equal to 0.20 W/m/° C., an addition in the range of 10% in weight of aluminium takes the overall conductivity of the compound material to about 0.23 W/m/° C., while an addition of aluminium in the range of 15% in weight takes the overall conductivity to about 0.26 W/m/° C.

More consistent additions of aluminium give correlated increases in conductivity until an overall conductivity of about 0.60 W/m/° C. is obtained by means of an addition of aluminium equal to about 50% in weight of the base material.

According, to a variant, instead of or together with the aluminium, the invention provides to add desired and controlled quantities of copper and/or nickel and/or other metals having identical or comparable characteristics.

Although here we have described a preferential embodiment of the invention, it is clear that any skilled person in the art can identify modifications and variants which shall, however, come within the field and scope covered by the invention.

1- Method to determine a material having characteristics of heat regulation, said material being able to be used in the design of footwear body suits, head-covers, padding, gloves or other garments which can be associated with parts of the human body, characterized in that it provides to calculate at least the value of heat conductivity (α) of said material able to provide a desired condition of thermophysiological comfort, starting from at least a value of heat conductivity (α₀) and a value of thickness (d₀) of the material assumed as initial value, the method providing a first step wherein the microclimatic conditions to which the part of the body concerned is subject are calculated using, in said calculation, said initial value of heat conductivity (α₀) and thickness (d₀) of the material, and a plurality of subsequent steps wherein said initial value of heat conductivity (α₀) is modified with an iterative process until said microclimatic conditions converge towards said desired condition of thermophysiological comfort.

2- Method as in claim 1, characterized in that it provides, at the start of the calculation, to define constraint conditions comprising at least one of the physical parameters of the article of clothing to be designed, selected from length, width or thickness.

3- Method as in claim 2, characterized in that said constraint conditions comprise at least statistical environmental parameters relative to the most probable situations of use of the article of clothing to be designed.

4- Method as claim 3, characterized in that said statistical environmental parameters comprise at least the identification of a context of use identified at least by a geographical zone of use, a typical time period, or by the working habits of the user.

5- Method as claim 1 characterized in that said desired condition of thermophysiological comfort of the user is obtained analytically by means of statistical identification of subjective conditions of a plurality of users grouped together according to specific target.

6- Method as in claim 5, characterized in that said specific target comprises persons grouped together at least according to one characteristic chosen among sex, age or build.

7- Method as in claim 5, characterized in that said statistical identification is achieved by mean of performing, on a significant sample of selected users, tests and measurements of a biomedical type of the temperature and/or skin surface humidity of a part of the body concerned in the application of said garment to be designed.

8- Method as in claim 7, characterized in that said statistical identification is suitable to identify microclimatic conditions wherein there is substantial constancy of the heat exchange between part of the body and outside environment through the material to be designed.

9- Method as in claim 7 or 8, characterized in that said statistical identification is suitable to identify conditions of minimum perspiration of the part of the body concerned.

10- Method as in any claim hereinbefore, characterized in that said calculation of the value of conductivity (α) is performed by means of a model able to simulate the development of the propagation of the heat, at least in terms of power dispersed (Pd), between part of the body and outside environment through the layer of material to be designed, said model receiving as input data at least said contour conditions and at least an initial value, assumed through hypothesis, of heat conductivity (α) of said material.

11- Method as in claim 10, characterized in that said model is able to perform a comparison between the conditions of heat propagation and surface temperature distribution according to said input data and the conditions corresponding to the situation of thermophysiological comfort, and to modify with an iterative process at least the value of heat conductivity (α) until said calculated conditions converge towards said situation of thermophysiological comfort with a desired tolerance.

12- Method as in claim 11, characterized in that said tolerance is in the order of ±1° C.

13- Method according to any of claims 1 to 12, wherein the material is a polymeric material having a quantity of at least a suitably chosen metallic substance added thereto in order to modify the heat conductivity of the compound.

14- Method as in claim 13, wherein said metallic substance is alluminum.

15- Method as in claim 13, wherein said metallic substance is copper.

16- Method as in claim 13, wherein said metallic substance is nickel.

17- Material having characteristics of heat regulation and able to be used in the design of footwear, body suits, head-covers, padding, gloves or other garments which can be associated with parts of the human body, said material having a required value of heat conductivity (α), characterized in that it consists of polymeric material having a heat conductivity equal to 0.20 W/m/° C. and mixed with a quantity of aluminium in the range of 10% in weight to take the overall value of heat conductivity (α) equal to about 0.23 W/m/° C.

18- Material as in claim 17, characterised in that it consists of polymeric material having a heat conductivity equal to 0.20 W/m/° C. and mixed with a quantity of aluminum equal to about 50% in weight to take the overall value of heat conductivity (α) equal to about 0.60 W/m/° C.
